(19) United States
(12) Patent Application Publication
(10) Pub. No.: US 2026/0312689 A1
(43) Pub. Date: Oct. 8, 2026

(54) LOW-COMPLEXITY PHOTONIC TRANSCEIVER

(71) Applicant: HEPT Lab, Inc., Tujunga, CA (US)

(72) Inventors: Aroutin Khachaturian, Tujunga, CA (US); Austin Fikes, Tujunga, CA (US); Babak Bahari, Tujunga, CA (US); Seyed Ali Hajimiri, La Canada Flintridge, CA (US)

(73) Assignee: HEPT Lab, Inc., Tujunga, CA (US)

(21) Appl. No.: 19/483,921

(22) PCT Filed: May 15, 2024
(86) PCT No.: PCT/US2024/029441

§ 371 Date: Nov. 12, 2025

Related U.S. Application Data
(60) Provisional application No. 63/466,659, filed on May 15, 2023.

(51) Int. Cl. H04B 10/40; G02B 6/126; G02B 6/27

(52) U.S. Cl. CPC H04B 10/40; G02B 6/126; G02B 6/2766

(57) ABSTRACT

A low-complexity photonic transceiver includes a low-complexity control for controlling the components of the low-complexity transceiver, a coherent source for generating electromagnetic radiation, an on-chip photonic wavefront processing block or processor for modulating the electromagnetic radiation, as well as a photonic transceiver array for transmitting and receiving electromagnetic radiation. Feedback is provided to the coherent source and/or on-chip photonic wavefront processing block/processor for both analog and digital calibration, using a sample of the output from the on-chip photonic wavefront processing block/processor.

### CROSS REFERENCE TO RELATED APPLICATION

This application claims the benefit under 35 U.S.C. Section 119(e) of the following co-pending and commonly-assigned application:

U.S. Provisional Application Ser. No. 63/466,659, filed on May 15, 2023, by Aroutin Khachaturian, Austin Fikes, Babak Bahari, and Ali Hajimiri, entitled “LOW COMPLEXITY PHOTONIC TRANSCEIVER,” attorneys' docket number G&C 306.0002USP1;
which application is incorporated by reference herein.

### BACKGROUND OF THE INVENTION

### 1. Field of the Invention

The present invention is related to a low-complexity photonic transceiver and methods of making the same.

### 2. Description of the Related Art

Compact photonic transceivers require multiple high-efficiency sub-blocks for optimum operations. Typical photonic transceivers require beamforming and beam steering blocks, efficient control of the beam forming and beam steering blocks, as well as coherent processing blocks, which increases the complexity of the transceiver. What is needed, then, is a photonic transceiver that can achieve the required functionality but with reduced complexity. The present invention satisfies that need.

### SUMMARY OF THE INVENTION

The present disclosure describes a novel low-complexity photonic transceiver architecture or system. In one or more embodiments, the system includes an (e.g., on-chip) photonic wavefront processing block or signal conditioning block for conditioning the light/electromagnetic beam (e.g., comprising optical phase and amplitude modulators), and a photonic transceiver array or beam steering block for beam forming and/or steering of the beam (e.g., comprising radiator arrays with coherent radiator cells). The system optionally further comprises a low-complexity control for controlling components of the low-complexity transceiver including a coherent source for generating the electromagnetic radiation, and/or the wavefront processor/signal conditioning block. The system further optionally comprises analog and digital calibration blocks for generating feedback to the coherent source and/or on-chip photonic wavefront processing block for both analog and digital calibration, using a sample of an output from the on-chip photonic wavefront processing block.

Embodiments of the photonic transceiver can be implemented with integrated photonic and coherent processing, optical switch circuits, low complexity control, and beam steering/forming.

### BRIEF DESCRIPTION OF THE DRAWINGS

Referring now to the drawings in which like reference numbers represent corresponding parts throughout:

FIG. 1 is a schematic of a low-complexity photonic transceiver with calibration feedback according to an embodiment of the invention.

FIG. 2 is a schematic illustrating individual access control of an exemplary component array.

FIG. 3 is a schematic illustrating a splitter tree, also known as a switching tree, with a reduced control node count.

FIG. 4 is a circuit diagram of a settable/resettable capacitor subcircuit.

FIG. 5 is a schematic of an array of capacitors in a reduced control node scheme.

FIG. 6 is a schematic of a co-integrated transmitter/receiver unit cell.

FIG. 7 is a schematic of a radiator comprising a transmitter waveguide and a coupler showing how a change in wavelength outputted from the grating results in a pattern having an increase in the number of resolvable far field spots in one direction.

FIG. 8 illustrates how a change in wavelength can be used for high resolution beam forming in 1 dimension as part of a 2 dimensions bear steering where the second dimension beam steering is achieved via focal plane array or phased array methodology.

FIG. 9 is a schematic illustrating a transmitter/receiver that can be used as focal plane array or optical phased array.

FIG. 10 illustrates 1D beam steering for increasing the fill factor on a focal plane array using a wavelength sensitive radiator and wherein wavelength based beam steering is one dimensional (1D).

FIG. 11 is a flowchart illustrating an example process for making a transceiver according to one or more embodiments.

FIG. 12 is a flowchart illustrating an example process for operating a transceiver according to one or more embodiments.

FIG. 13. Example hardware environment.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

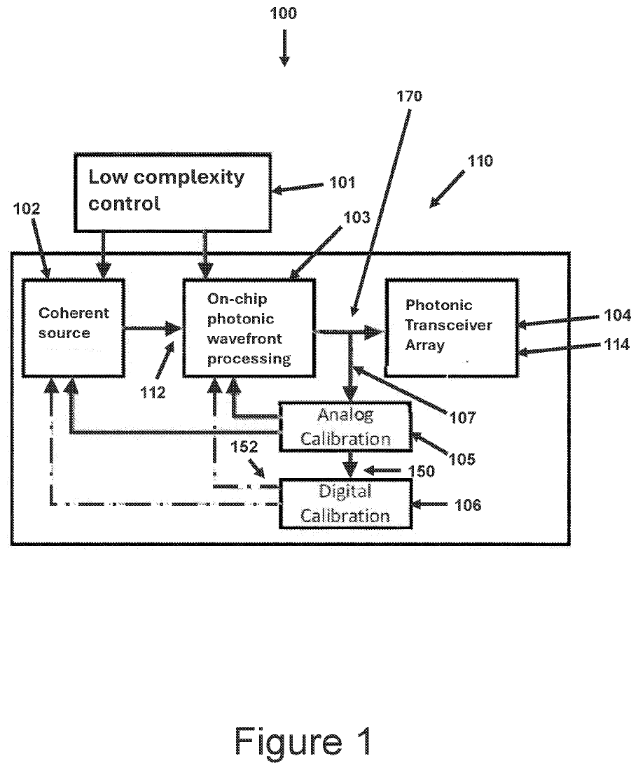

FIG. 1 is a schematic of a low-complexity photonic transceiver 100 with calibration feedback, according to an embodiment of the invention, including a low-complexity control 101 for controlling components of the transceiver 100, a coherent source 102 for generating a light/electromagnetic beam, an on-chip photonic wavefront processing block or processor 103 for modulating/processing the electromagnetic/light beam (e.g., using optical phase and amplitude modulators), a photonic transceiver array 104 for transmitting and/or receiving electromagnetic radiation, analog and/or digital calibration blocks or circuits 105, 106 for providing analog and/or digital feedback to the coherent source 102 and on-chip photonic wavefront processing block 103. The calibration blocks use a coherent sample of an output 107 from the on-chip photonic wavefront processing block 103 to determine the feedback.

The various blocks/processors 103, 104, 102 can be coupled via waveguides 170 for transmitting the coherent electromagnetic radiation.

The following sections provide more detail on the novel aspects of the low-complexity photonic transceiver 100. Section 2.1 describes how the low-complexity control 101 is implemented with low-complexity row-column circuits. Section 2.2 describes how the low-complexity control can be set and cleared to arbitrarily control the transceiver 100 with low-power capacitive components. Afterwards, two methods to reduce aperture and beam steering complexity are described. Section 2.3 describes how the complexity of the transceiver 100 can be reduced by using a common aperture architecture in the photonic transceiver array 104. Section 2.4 describes how high-resolution beam forming can be achieved using low-complexity adaptive apertures in the photonic transceiver array 104. Also discussed is integrated processing that enhances transceiver operations.

### 2.1 Row-column Switch Network

Method For Applying Bias Voltage/Current To An Array of Functional Nodes in an Electronic Circuit With Reduced Control Node Count In electronic systems, there are often many components which an individual control voltage or current dictates their operating state. Sensor arrays, electrical or optical switching networks, memory arrays, and other sets of components are all examples of circuits that require electrical bias established for a subset of the components. As these arrays grow in size, there is a proportional increase in the number of controls needed. The increasing control node count cause interface bottleneck issues, especially for compact form factor systems such as integrated circuits.

The present disclosure describes a method for the low-complexity control 101 to control (e.g., voltage and/or current to) at least one of the coherent source 102 or the on-chip photonic wavefront processing block 103 through a subset of array nodes with reduced control nodes. The method utilizes a set of drivers and a set of switches to establish control signals (e.g., bias) for specific nodes. A driver could be implemented in a variety of ways including, but not limited to, voltage digital-to-analog converters (DAC) with voltage buffers, current DACs, or other methods. A switch could be implemented using physical switches or transistors or interferometers (e.g. Mach Zehnder Interferometers). The method assumes that there is a non-linear device included in each node, such as a diode, that can provide isolation between nodes.

### 2.1.1 Individual Access Method

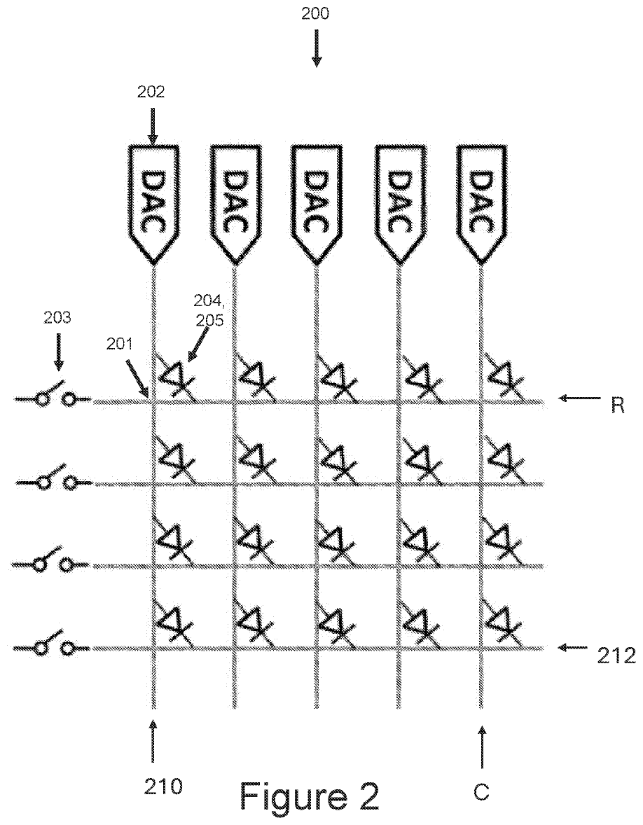

Consider a subset of an array 200 in which only one node 201 needs a specific bias at a time. We can consider the nodes 201 as a two-dimensional (2D) matrix of rows R and columns C. The columns share a driver (such as a DAC) 202 and the rows share a switch 203 to the ground reference of the driver 202. The nonlinear device 204 (e.g., diode 205) internal to each component to be controlled should be connected such that current flows from the driver 202 to the switch 203, and not the other way around. With N rows and M columns, N switches 203 and M drivers 202 are needed. For example, FIG. 2 illustrates a 20 component array 200 could be controlled by 4 switches 203 and 5 drivers 202, instead of 20 individual controls.

### 2.1.2 Subset Access Methods

There are additional advantages when deploying this technique in scenarios when there are several subsets of components (e.g., in the wavefront processor) which need to be accessed by the low-complexity control 101 in a related pattern. Switches can be shared across the subsets of components to further reduce the number of control nodes needed.

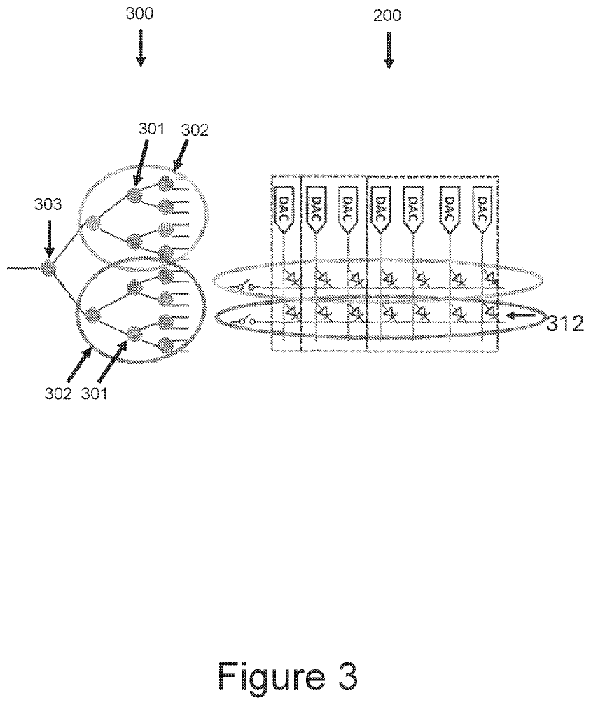

FIG. 3 is a schematic illustrating a splitter tree 300, also known as a switching tree 300, with a reduced control node count.

Consider a switching tree 300 in which the switching state of a node 301 is controlled by the current flowing through a diode. The nodes 301 of this switching tree 300 are referred to as “tree switches” 301 to distinguish them from the control switches 203, 303 that have been discussed above. As we progress through the tree 300, it is clear that the set of tree switches 301 that form a path should all be activated at the same time. These tree switches 301 can share a control switch 303. The branches 302 of the splitter tree 300 are individual rows in our control scheme. For those rows, there are 1, 2, and 4 DAC 202 driver groupings for each layer of the splitter tree 300. This figure shows a 1:16 splitter tree 300, for larger trees 300 the control node 303 savings are greater.

This method can be adapted to a variety of component nodes 201 in FIG. 2. For example, a switching tree 300 in which two diodes are needed to control each tree switch 301, two drivers 202 can be used for each tree switch 301 instead of one.

### 2.2 Capacitive Row-column Switch Network

### Method For Setting Voltage on an Array of Capacitors with Reduced Control Node Count

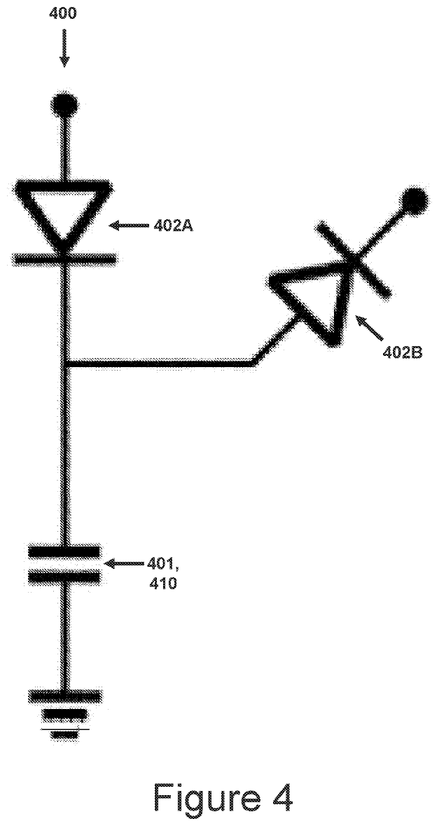

FIG. 4 is a circuit diagram of a settable/clearable capacitor subcircuit 400 used in the low-complexity control 101.

In a variety of electronic circuits, there may be several capacitors whose stored charge determines system behavior. In many scenarios, such as integrated circuits with limited input/output (I/O), it is advantageous to reduce the number of control nodes needed to set charge on an array of capacitors. The method for achieving that reduction starts with the subcircuit 400 as illustrated in FIG. 4. The capacitor 401 can represent a variety of devices including, lumped or distributed elements, reversed bias diodes, metal-oxide-semiconductor capacitors (MOS-CAPs), and/or metal-oxide-semiconductor field effect transistors (MOS-FETs), or capacitive optical modulators such as reverse-biased PN diodes, x⁽²⁾ modulators, or silicon-oxide-silicon modulators.

Charge can be deposited on the capacitor 401 by forward biasing a first diode 402A. Charge can be removed through a second diode 402B by pulling its n-doped node to low voltage.

To control an N×M array of such capacitors 401, we share the ground node within one of the N rows and the two diode nodes 402A, 402B among M columns. This means there are N+2M control nodes 201, as opposed to N×M control nodes 201 that would be needed for a naive approach.

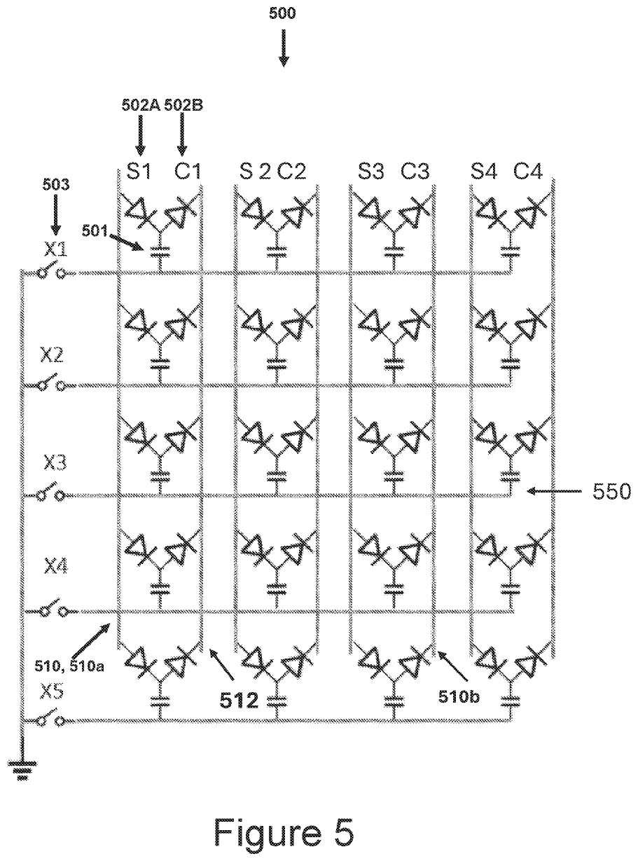

FIG. 5 is a schematic of an array 500 of capacitors 501 where N=5 and M=4, with set (Sⱼ) diodes 502A and clear (Cⱼ) diodes 502B. To set a value on a specific capacitor_{i,j} 501 (e.g., row i, column j), the switch Xᵢ 503 of its row should be closed, while the other switches X 503 are open. A voltage is then placed across diodes Sⱼ 502A of its column, while all other diodes S 502A are floating. The capacitor_{i,j} 501 of interest will be the only one with a complete circuit for current to flow, preserving the other values within the array 500 and setting its value. To discharge a capacitor_{i,j} 501, switch Xᵢ 503 and diode Cⱼ 502B are used.

### 2.3 Common Aperture Transceiver With Unified Radiator

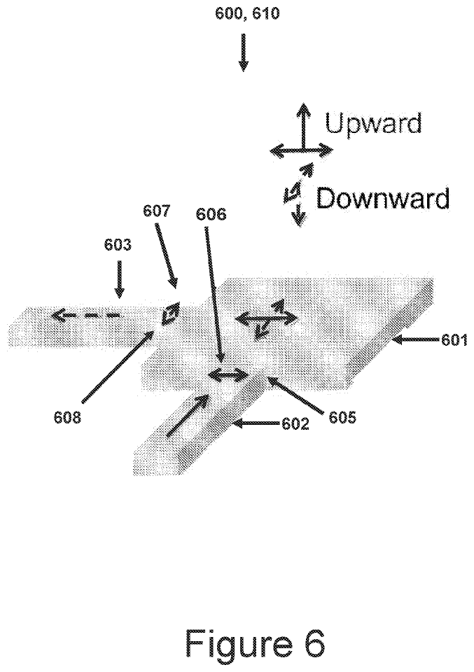

To reduce system complexity and reliability, a transmitter and receiver are co-integrated into the photonic transceiver array 104, which is a unified integrated sub-block. As shown in FIG. 6, the array comprises a plurality of combined or unified radiators 600 (e.g. comprising a coupler 601) for coupling light out of the integrated transceiver chip as well as collecting the light from space and coupling the light into the integrated transceiver chip. The coupler 601 uses polarization to isolate the transmitters and receivers, due to the transmitters and receivers having different polarization. The optical light from the transmitter waveguide 602 is transmitted by the coupler 601 to the space with a given polarization 606, and then the refracted light experiences a polarization rotation, which results in a coupling by coupler 601 to a different waveguide (receiver waveguide 603). In general, the polarization rotation is accomplished using an external component, such as quarter wave plate, but can be performed on-chip as well. The radiation pattern can be adjusted in design. The low-complexity transceiver 100 with high-resolution capability can be part of an optical phased array where some fraction of the two dimensional (2D) far-field beam steering is performed using different wavelengths.

### 2.4 Common Aperture Transceiver with Independent Radiators

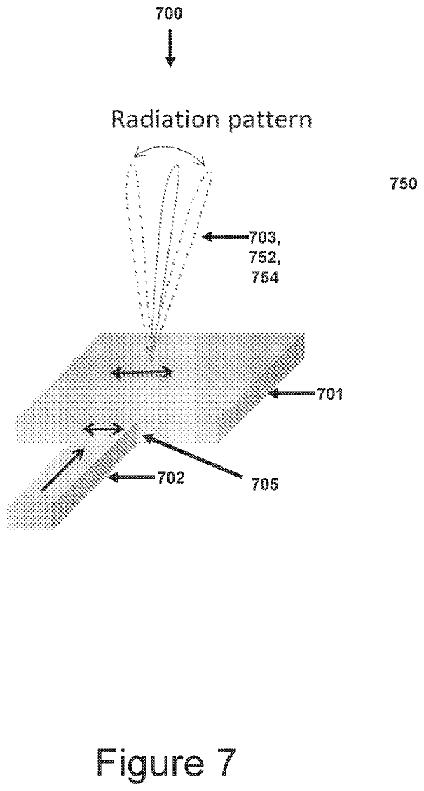

To enhance system beam forming capability, a radiator 700 (e.g., comprising a coupler 701 or grating) with high wavelength sensitivity is used to couple the light in/out of the chip. An array of radiators 700 placed in a two-dimensional grid, can operate both as a focal plane array and as an optical phased array. At a fixed wavelength, the array of radiators 700 provides a limited beam forming and beam steering capability with far-field resolvable spots on the order of the number of the radiators 700. The advantage of a wavelength-sensitive radiator 700 is that it enables increasing the number of far-field resolvable spots by changing the wavelength and/or changing the radiation direction 703 of the radiators 700, as shown in FIG. 7 for a radiator 700 comprised of coupler 701 coupled to a waveguide 702 (e.g., transmitter waveguide), which effectively increases the number of far-field resolvable spots. In another example, the transmitter and receiver radiators are combined into a combined radiator 600 as shown in FIG. 6.

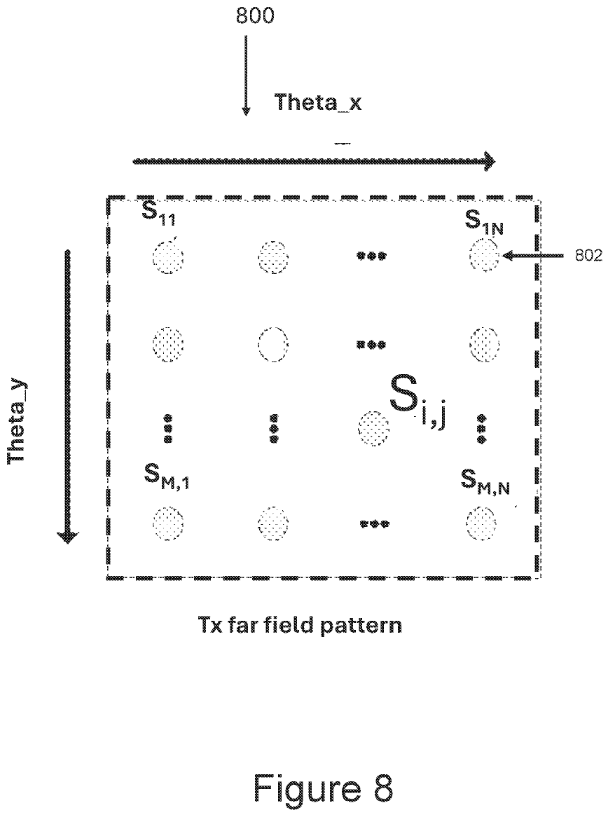

The low complexity transceiver with high-resolution capability can be part of an optical phased array where some fraction of the 2D far-field beam steering is performed using wavelength while the remaining fraction is achieved via an optical phased array or focal plane array. FIG. 8 shows how steering the beams forms a Tx far-field pattern 800 comprising an array of N×M spots 802, wherein the steering comprises tuning the angle Theta_X (θ_{X}) of the beam in the x coordinate direction and an angle Theta_Y (θ_{Y}) of the beam in the y coordinate direction.

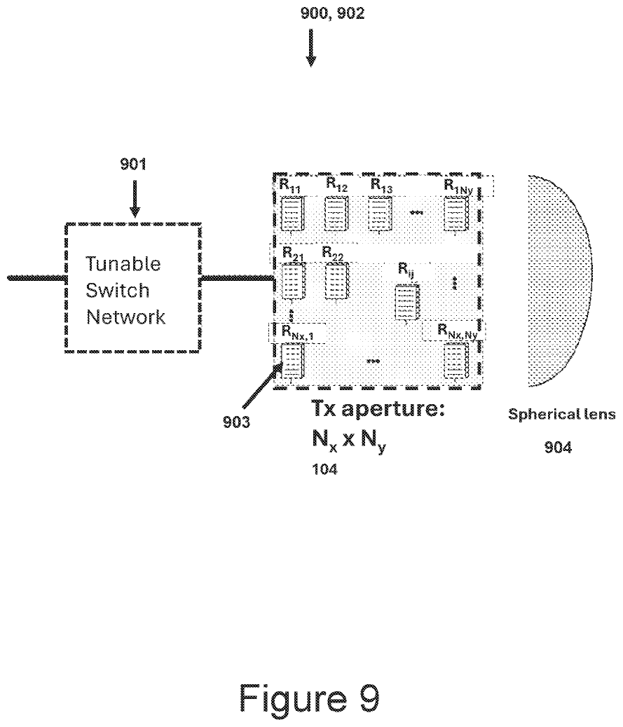

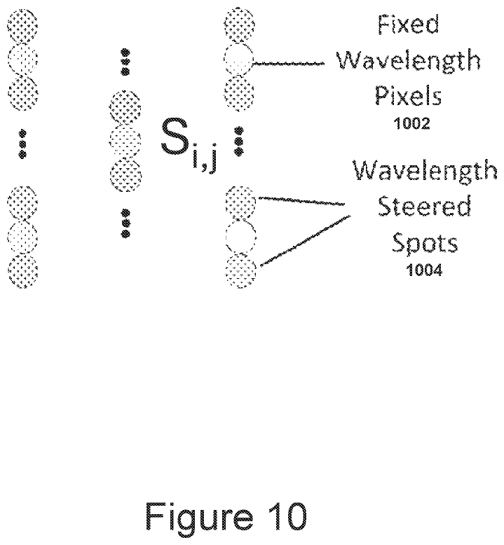

FIG. 9 illustrates an example of the aperture 104 comprising transceiver array 900 that is part of, or comprises a focal plane array, wherein high-resolution narrow-angle 1D or 2D beam steering is performed with a tunable switch network 901 (which can be part of the wavefront processor) controlling the array the wavelength sensitive radiators 903 and light is collected on the array using a spherical lens 904. FIG. 10 shows how this method can be used to increase the fill-factor of the focal-plane array. FIG. 10 illustrates fixed wavelength pixels 1002 and wavelength steered spots 1004.

In FIG. 10, the spots 1002 are from pixels of the focal plane array for a particular wavelength. Wavelength steered spots 1004 correspond to the same physical pixel but different wavelength.

In one or more examples, the tunable switch network 901 has a wide enough bandwidth to send all desired wavelengths to the same radiator. If required, the network can be retuned for any particular wavelength. The tunable switch network can be configured to go from broadband to narrowband. The tunable switch network can comprise a pass through for all wavelengths wherein it does not pose as a wavelength steering bottleneck. In another embodiment, the network can be adjusted for narrowband operation for any particular wavelength.

The 1:N tunable switch network 901 can be realized using an array of Mach Zehnder Interferometer (MZI) optical switches that are quadrature biased to reduce the drive voltage required. More complex MZI switches can be implemented with quadrature tuning capability and relative output phase tuning capability for an enhanced and more precise tunable switch network 901. In one or more embodiments, these switches are broadband compared to range of wavelength that pass through them. The switch sends all the input light to a particular output.

FIG. 9 also illustrates that a wavelength sensitive radiator 903 in the focal plane array 902 for an enhanced fill factor can be realized by using a wavelength sensitive grating as the radiator 903 in conjunction with a standard lens 904. Alternatively, a wavelength insensitive grating can be used in conjunction with a diffraction grating as the radiator 903, and a standard lens 904. In one or more embodiments, the wavelength insensitive grating can be a binary phase grating, an amplitude grating, or any grating designed to have a large bandwidth (much larger than the range of wavelengths that it is radiating). Examples of wavelength insensitive gratings include gratings that have some wavelength sensitivity but wavelength insensitivity with respective to the range of operation wavelengths, e.g., of the electromagnetic radiation transmitted or received by the transceiver.

Alternatively, a wavelength insensitive radiator 903 can be combined with a meta-lens structure where the transformation of the diffraction grating 903 and the lens 904 is handled by the meta-lens structure. Examples of meta lenses include, but are not limited to, nanostructures that can be separate from the chip or can be integrated with the chip.

### 2.5 Enhanced Signal Processing

FIG. 1 illustrates how a low-complexity photonic transceiver 100 incorporates calibration schemes 105, 106 to cancel out process variations, environmental variations, etc., as well as coherent source 102 fluctuations. The on-chip calibration blocks 105, 106 measure the contribution of various factors and adjust the generating of the light beam by the coherent source 102, as well as the conditioning of the light beam by the on-chip photonic wavefront processing block 103, by sampling the signal 107, 150 from the on-chip photonic wavefront processing 103. The signal 107 is a coherent sampled wavefront that is processed on-chip and can be used for analog domain calibration 105. One method of realizing the coherent samples is to mixed the output signal form block 103 with a delayed version of itself in the form of on-chip heterodyne mixing. In addition, the output signal 107 can be digitized and used for digital domain calibration 106.

In some examples, the integrated processing of the low-complexity photonic transceiver 100 increases signal acquisition rate by reducing the time required for calibration, noise and leakage rejection, and interference suppression. The integrated processing can capture both the amplitude and phase of the wavefront and use it to calibrate various sources of interference, speckle, and noise. The calibration can be achieved by processing one time segment T at a time, or by iteratively estimate the incoming data in real time.

### 3 Process Steps

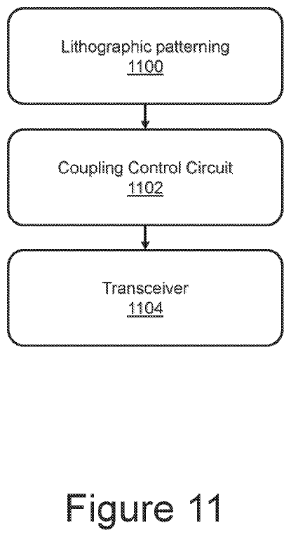

FIG. 11 illustrates a method of fabricating a transceiver.

Block 1100 represents using lithographic patterning of a substrate (e.g., a silicon on insulator substrate) to form the integrated circuit comprising an input for receiving a coherent electromagnetic radiation; at least one aperture for at least one of transmission or reception of the electromagnetic radiation; and a wavefront processor comprising an array of nodes. The coherent source can be manufactured in another semiconductor platform (e.g., Indium phosphide, InP) that is integrated with the silicon platform (e.g., using an InP membrane on Silicon IMOS process). Example methods of manufacturing such integrated circuits are discussed in [1]). The array of nodes, drivers, and switches can be manufactured using electronic integrated circuit processing techniques, e.g., in complementary metal oxide semiconductor (CMOS) platforms such as CMOS silicon photonics. In one or more embodiments, the transceiver is implemented in a variety of standard silicon photonic, indium phosphide photonic, or any other nanophotonic platform that offers on-chip photonic waveguides. For example, the waveguides can comprise silicon waveguides clad by silicon dioxide.

The waveguides can be more generally paths for transmitting the signal comprising electromagnetic radiation, waves, or fields (e.g., having any wavelength including, but not limited to, wavelengths in a range from visible to infrared) used to generate (or that are received in response to) the electromagnetic radiation (e.g., photons) transmitted from (or received on) the radiator. The electromagnetic radiation/waves/fields can be modulated with signals (e.g., waveforms) at various frequencies including, but not limited to, radio frequencies.

As described herein, the nodes in the array of nodes can each comprise a modulator (e.g., phase shifter) comprising a material (e.g., liquid crystal or nonlinear material, or electro-optic material, or thermo-optic material) thermally or electrically coupled to an electrode, wherein application of a voltage to the electrode (via bias lines connected to a driver) controls, e.g., resistive heating, piezoelectric actuation, bi refringence, or electro-optic actuation of the material so as to control a phase of the electromagnetic field passing through the material. Such modulators can be coupled to waveguides carrying the electromagnetic field, e.g., in an interferometer, to further modulate the phase. Other example nodes include, but are not limited to, capacitors, lumped or distributed elements, reversed bias diodes, metal-oxide-semiconductor capacitors (MOS-CAPs), and/or metal-oxide-semiconductor field effect transistors (MOS-FETs), or capacitive optical modulators such as reverse-biased PN diodes, x⁽²⁾ modulators, or silicon-oxide-silicon modulators.

A driver could be implemented in a variety of ways including, but not limited to, voltage digital-to-analog converters (DAC) with voltage buffers, current DACs, or other methods. A switch could be implemented using physical switches, electronic switches (transistors), or optical switches (e.g., interferometers, MZI interferometers).

Block 1102 represents coupling a control circuit to the transceiver chip. The control circuit can be included in the integrated circuit or located on as a separate chip or separate integrated circuit or computer or computing system. The control circuit can comprise a computer (e.g., one or more integrated circuit, application specific integrated circuit (ASIC), field programmable gate array (FPGA)).

Block 1104 represents the end result, a transceiver.

The device can be implemented in many ways including, but not limited to, the following:

1. A transceiver chip 110, comprising:
an integrated circuit comprising:
an input 112 for receiving coherent electromagnetic radiation outputted from a coherent source 102 of electromagnetic radiation;
at least one aperture 114 for at least one of transmission of transmitted electromagnetic radiation or reception of received electromagnetic radiation;
a wavefront processor 103 comprising an array 200 of nodes 201 operable, in response to activation by a plurality of drivers 202 and a plurality of switches 203, for at least one of:
modulating the coherent electromagnetic radiation, when received from the coherent source, to form a waveform of the transmitted electromagnetic radiation transmitted by the aperture; or
determining a phase and an amplitude of a received waveform from received signals generated by the aperture in response to received electromagnetic radiation received on the aperture; or
configuring the aperture 114 as at least one of a transmitter aperture for transmitting the transmitted electromagnetic radiation or a receiver aperture for receiving the electromagnetic radiation; and
wherein:
a sum of a number of drivers 202 and a number of the switches 203 is less than a number of the nodes 201, or
the switches comprise control switches 303 each controlling a splitter tree 300 connected to a plurality of the nodes 201 and a sum of the number of drivers 202 and a number of the control switches 303 is less than the number of the nodes 201.

2. The transceiver chip of clause 1, wherein:
the array of nodes are disposed in rows R and columns C;
the drivers 202, operable to set an operation state of a plurality of the nodes; are connected to a plurality of M common column driver lines 210 or a plurality M of pairs 510 of common column driver lines 512, wherein (for 1≤j≤M) the j^{th} one of the common column driver lines, or the j^{th} one of the pairs, couples the nodes in the j^{th} one of the columns C to the j^{th} one of the drivers 202; and
each of the switches 303 are connected to one or more of a plurality N of common row lines 212, wherein the i^{th} one of the common row lines (for 1≤i≤N) is coupled to the nodes in the i^{th} one of the rows R.

3. The transceiver chip of clause 2, wherein P=M×N, where P is the number of the nodes 201.

4. The transceiver chip of any of the clauses 1-2, wherein the nodes each further comprise a diode 205 isolating the nodes from one another so that current flows from the driver to the switch connected to the associated one of the nodes and not the other way around.

5. The transceiver chip of any of the clauses 1, 2, or 3 further comprising a splitter tree 300 comprising a splitter circuit connecting each of one or more of the switches, comprising control switches 303, to a subset of the common row lines 312, wherein the splitter tree comprises tree nodes comprising tree switches 301, each of the tree switches operable to switch a current from the each of the one or more control switches 303 to one of the common row lines 312.

6. The device of any of the clauses 1-5, wherein:
each of the nodes comprises a charge storing device 410 coupled to a first diode 502A in a forward bias configuration and a second diode 502B in a reverse bias configuration, so that charge is applied to the charge storing device through the first diode and removed through the second diode;
each of the N common row lines 550 comprise a reference or ground line;
the M pairs of common column lines each comprise a charge line 510a and a clear line 510b, wherein the charge line is connected to the first diode and the clear line is connected to the second diode;
to charge the charge storing device 410 at the i^{th} row and j^{th} column, the i^{th} one of the switches 503 is closed while the remaining ones of the switches are open 503, and the one of the drivers 202 of the j^{th} one of the pairs 510 biases the j^{th} one of the first diodes 502A through the charge line while the remaining ones of the diodes are floating; and
to discharge the charge storing device 410 at the i^{th} row and j^{th} column, the i^{th} one of switches 503 is closed and the one of the drivers 202 of the m^{th} pair 510 biases the second diode 502B through the clear line 510b while the remaining ones of the diodes are floating.

7. The transceiver of any of the clauses 1-6, wherein the switches 203 comprise transistors and/or optical switches, the nodes 201 comprise modulators comprising phase shifters, the drivers 202 comprise a digital-to-analog converters (DAC) with a voltage buffer applying a voltage or a current DAC applying a current, and the wavefront processor, the aperture, and the input from the coherent source are connected by optical waveguides.

8. The transceiver chip of any of the clauses 1-7, wherein the aperture comprises:
a photonic integrated circuit comprising an array of cells 610 each comprising a polarization selective radiator 600 component comprising an input 605 from a transmitter waveguide 602 and an output 607 to a receiver waveguide 603, wherein the polarization selective radiator component accepts a first polarization 606 of the coherent electromagnetic radiation from the transmitter waveguide and routes a second polarization 608 of the received electromagnetic radiation, received on the polarization selective radiator, to the receiver waveguide.

9 The transceiver chip of any of the clauses 1-8; wherein:
the aperture 114 comprises a photonic integrated circuit comprising an array of radiators 700 each comprising an input/output interface 705 to a waveguide 702;
the wavefront processor 103 coupled to the waveguide is operable to configure the array as an optical phased array or a focal plane array.

10. The transceiver chip of clause 9, wherein:
the radiators 700 comprise wavelength sensitive radiators,
the wavefront processor 103 is operable to configure the array of radiators as an optical phased array controlling at least one of beam forming or beam steering 752 of the transmitted electromagnetic radiation 754 radiated from the radiators to form a plurality of resolvable spots 802 in a far field 800, wherein a number of the resolvable spots is controlled by the wavefront processor 103 controlling a wavelength and a direction of the transmitted electromagnetic radiation transmitted from one or more of the radiators.

11. The transceiver of clause 9, wherein:
the radiators 903 comprise a wavelength sensitive radiator, and
the wavefront processor 103 is operable to configure the array of radiators as a focal plane array 902 controlling steering of the received electromagnetic radiation onto the radiators, so that a fill factor of the focal plane array can be increased by the wavefront processor 103 changing a wavelength of the electromagnetic radiation transmitted from one or more of the radiators 903.

12. The transceiver chip of any of the clauses 9-11, wherein the radiators 903 comprise a diffraction grating.

13. The transceiver chip of any of the clauses 9-12, wherein the wavelength sensitive radiator 903 comprises a wavelength sensitive grating in combination with a lens 904, a wavelength insensitive grating in combination with a diffraction grating and a lens, or a wavelength insensitive radiator in combination with a meta-lens structure performing a function of a diffraction grating and a lens.

14. The transceiver chip of any of the clauses 1-13, wherein the coherent source 102 is on the chip 110 or off the chip 110.

15. The transceiver chip of any of the clauses 1-14, comprising a second array 200 of nodes 201 coupled to the coherent source for controlling the coherent electromagnetic radiation inputted to the input, wherein the coherent source further optionally comprises a plurality of sources emitting different wavelengths.

16. The transceiver chip of any of the clauses 1-15, further comprising a plurality of the chips each comprising or coupled to the coherent source emitting at a different wavelength, or a plurality of the coherent sources emitting at different wavelengths working in conjunction with a plurality of the photonic chips.

17. The transceiver chip of any of the clauses 1-16, wherein the integrated circuit further comprises a calibration circuit 105, 106 coupled to the wavefront processor 103, the calibration circuit comprising a sample input 150 for receiving a sample 107 of the wavefront and an calibration output 152 providing feedback to the wavefront processor in response to the sample, wherein the wavefront processor applies an adjustment to the wavefront in response to the feedback to at least partially cancel noise in the wavefront caused by at least one of manufacturing non-uniformities in the transceiver or an environment 750 through which the transmitted electromagnetic radiation 754 is transmitted.

18. The transceiver chip of clause 17, wherein the calibration circuit determines the adjustment from a comparison of a phase and amplitude of the waveform outputted to the aperture for transmission, with the phase and amplitude of the received waveform received on the aperture, at a plurality of different times for during a plurality of different time segments.

19. The transceiver chip of clause 17, 18, or 19, wherein the calibration circuit estimates the adjustment by comparing a phase and amplitude of the waveform outputted to the aperture with for transmission, with the phase and amplitude of the received signals in real time as the received electromagnetic radiation is received on the aperture, and the adjustment is applied in an iterative manner so that the phase and amplitude of the received waveform or received signal reaches certain acceptance criteria determined by the particular sensing application (e.g., the received phase and amplitude won't be same as transmitted waveform phase and amplitude). Example (e.g., sensing) applications include, but are not limited to, LIDAR, remote sensing, collision avoidance, or object detection e.g., for self driving vehicles.

20. An integrated circuit comprising the transceiver of any of the clauses 1-19, wherein the wavefront processor sets an acquisition rate of the received signals commensurate with, or correlated, with the adjustment.

21. A system 100 comprising the transceiver chip 110 of any of the clauses 1-20, further comprising a control circuit 101 coupled to at least one of the wavefront processor 103 or the coherent source 102 and operable to control the wavefront processor by routing control signals setting at least one of outputs from drivers, open or close state of the switches, wavelength of the coherent electromagnetic radiation outputted from the coherent source, or intensity of the coherent electromagnetic radiation outputted from the coherent source.

22. A Light Detection and Ranging (LIDAR) system or remote sensing system comprising the transceiver chip of any of the embodiments, wherein the transmitted electromagnetic radiation is used for LIDAR or remote sensing.

23. The device of any of the clauses 1-22, wherein the electromagnetic radiation has any wavelength, including, but not limited to, from ultraviolet to infrared.

24. The device of any of the clauses 1-23, wherein the array of nodes is located on chip or off chip (e.g., in the control circuit 101).

25. A circuit useful in a photonic transmitter or photonic receiver, comprising:
an array of nodes disposed in rows and columns;
a plurality of drivers;
a plurality of switches;
a plurality of common row lines coupled to each of the nodes in one or more of the rows, each of the common row lines connected to a different one of the switches; and
a plurality of common column driver lines coupled to each of the nonlinear components in one or more of the columns, so that a number of the drivers and a number of the switches is less than a number of the nodes.

26. The circuit of clause 25 used with the transceiver of any of the clauses 1-24.

27. An aperture useful in a transmitter and/or receiver, wherein the aperture comprises:
a photonic integrated circuit comprising an array of cells 610 each comprising a polarization selective radiator 600 component comprising an input 605 from a transmitter waveguide 602 and an output 607 to a receiver waveguide 603, wherein the polarization selective radiator component accepts a first polarization 606 of the coherent electromagnetic radiation from the transmitter waveguide and routes a second polarization 608 of the received electromagnetic radiation, received on the polarization selective radiator, to the receiver waveguide.

28. An aperture useful in a transmitter and/or receiver, wherein the aperture 114 comprises a photonic integrated circuit comprising an array of radiators 700 each comprising an input/output interface 705 to a waveguide 702:
the wavefront processor 103 coupled to the waveguide is operable to configure the array as an optical phased array or a focal plane array.

29. The aperture of clause 27 or 28 comprising the device of any of the clauses 9-13 or used in conjunction with the transceiver of any of the clauses 1-24.

30. The device of any of the clauses 1-29, wherein the transmitted electromagnetic radiation and received electromagnetic radiation are used for LIDAR, remote sensing, collision avoidance, or object detection e.g., for self driving vehicles.

31. The device of any of the clauses 1-30, wherein the aperture comprises an array of radiators and comprises or is coupled to a tunable switch network transmitting the coherent electromagnetic radiation or waveform from the wavefront processor to the radiators, wherein the wavefront processor comprises the tunable switch network or is connected between the wavefront processor and the aperture.

32. The device of clause 31, wherein the tunable switch network comprises an array of Mach Zehnder Interferometers (MZI).

33. The device of claim 31 or 32, wherein the tunable switch network can be configured for pass the coherent electromagnetic radiation going from broadband pass to narrowband pass, comprise a pass through for all wavelengths of the coherent electromagnetic radiation without posing as a bottleneck for wavelength steering of the electromagnetic radiation, or wherein the tunable switch network can be adjusted for narrowband operation for any particular wavelength of the coherent electromagnetic radiation.

34. A low-complexity photonic transceiver, comprising:
a low-complexity control for controlling the low-complexity photonic transceiver;
a coherent source for generating a light beam;
an on-chip photonic wavefront processing block for conditioning the light beam using both optical phase and amplitude modulators;
a photonic transceiver array for beam forming and beam steering of the light beam; and
analog and digital calibration blocks for generating feedback to the coherent source and on-chip photonic wavefront processing block for both analog and digital calibration, using a sample of an output from the on-chip photonic wavefront processing block;
wherein:
voltage and/or current for the coherent source and on-chip photonic wavefront processing block are controlled by the low-complexity control through array nodes with control nodes; and
a set of drivers and a set of switches are utilized to establish a bias for specific ones of the array nodes and control nodes.

35. The device of clause 34, wherein the drivers comprise voltage digital-to-analog converters (DACs) with voltage buffers, current DACs, or other methods.

36. The device of claim 34, wherein each of the array nodes and control nodes includes a non-linear device such as a diode that provides isolation between the nodes.

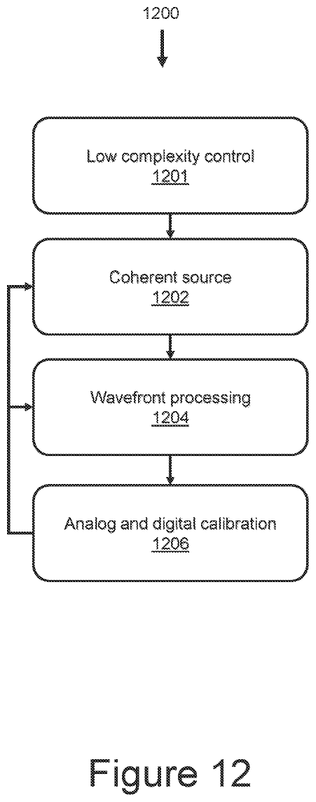

FIG. 12 illustrates the steps of a method 1200 for operating a transceiver according to embodiments described herein.

The method comprises controlling (Block 1200) a plurality of nodes in or coupled to a coherent source (1202) and/or a wavefront processor (1204) using a plurality of drivers and a plurality of switches for at least one of controlling a waveform of electromagnetic radiation for at least one of beam forming or beam steering of the electromagnetic radiation transmitted from the transceiver, or determining a phase and an amplitude of a received waveform of electromagnetic radiation received on the transceiver, or configuring an aperture of the transceiver as at least one of a transmitter aperture for transmitting the electromagnetic radiation or a receiver aperture for receiving the electromagnetic radiation; and wherein a sum of a number of drivers and a number of the switches is less than a number of the nodes, or the switches comprise control switches each controlling a splitter tree connected to a plurality of the nodes and a sum of the number of drivers and a number of the control switches is less than the number of the nodes. In one or more examples, the phase and amplitude of the received waveform is determined by combining the received signals with a portion of the coherent electromagnetic radiation (e.g., by mixing) and analyzing the mixed signal.

In one or more examples, the nodes comprise modulators for modulating a phase and/or amplitude of the electromagnetic radiation.

The method optionally further comprises performing a calibration (Block 1206) comprising receiving a sample of the wavefront and providing feedback to the wavefront processor in response to the sample, wherein the wavefront processor applies to the wavefront in response to the feedback to at least partially cancel noise in the wavefront caused by at least one of the transceiver or an environment through which the transmitted electromagnetic radiation is transmitted.

The method can be implemented using embodiments of the transceiver chip described herein, including but not limited to, the any of the transceiver chips described in clauses 1-36.

### Hardware Environment

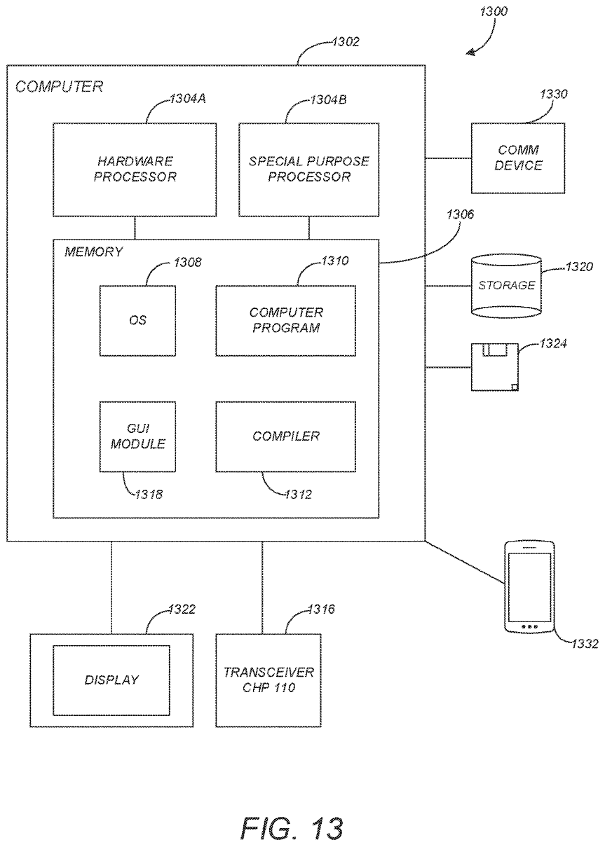

FIG. 13 is an exemplary hardware and software environment 1300 (referred to as a computer-implemented system and/or computer-implemented method) used to implement one or more embodiments of the invention, e.g., wavefront processing 103, or control 101, or calibration 105. The hardware and software environment includes a computer 1302 and may include peripherals. Computer 1302 may be a user/client computer, server computer, or may be a database computer. The computer 1302 comprises a hardware processor 1304A and/or a special purpose hardware processor 1304B (hereinafter alternatively collectively referred to as processor 1304) and a memory 1306, such as random access memory (RAM). The computer 1302 may be coupled to, and/or integrated with, other devices, including input/output (I/O) devices. In one or more embodiments, computer 1302 may be coupled to, or may comprise, a portable or media viewing/listening device 1332 (e.g., a multi-touch device, mobile phone, cell phone executing on various platforms and operating systems.

In one embodiment, the computer 1302 operates by the hardware processor 1304A performing instructions defined by the computer program 1310 (e.g., application for providing control 101 of the nodes 201) under control of an operating system 1308. The computer program 1310 and/or the operating system 1308 may be stored in the memory 1306 and may interface with the user and/or other devices to accept input and commands and, based on such input and commands and the instructions defined by the computer program 1310 and operating system 1308, to provide output and results.

Output/results may be presented on the display 1322 or provided to another device for presentation or further processing or action. The image may be provided through a graphical user interface (GUI) module 1318. Although the GUI module 1318 is depicted as a separate module, the instructions performing the GUI functions can be resident or distributed in the operating system 1308, the computer program 1310, or implemented with special purpose memory and processors.

Some or all of the operations performed by the computer 1302 according to the computer program 1310 instructions may be implemented in a special purpose processor 1304B. In this embodiment, some or all of the computer program 1310 instructions may be implemented via firmware instructions stored in a read only memory (ROM), a programmable read only memory (PROM) or flash memory within the special purpose processor 1304B or in memory 1306. The special purpose processor 1304B may also be hardwired through circuit design to perform some or all of the operations to implement the present invention. Further, the special purpose processor 1304B may be a hybrid processor, which includes dedicated circuitry for performing a subset of functions, and other circuits for performing more general functions such as responding to computer program 1310 instructions. In one embodiment, the special purpose processor 1304B is an application specific integrated circuit (ASIC) or field programmable array (FPGA), or other integrated circuit.

The computer 1302 may also implement a compiler 1312 that allows an application or computer program 1310 written in a programming language such as C, C++, Assembly, SQL, PYTHON, PROLOG, MATLAB, RUBY, RAILS, HASKELL, or other language to be translated into processor 1304 readable code. Alternatively, the compiler 1312 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1310 accesses and manipulates data accepted from I/O devices and stored in the memory 1306 of the computer 1302 using the relationships and logic that were generated using the compiler 1312.

In one embodiment, instructions implementing the operating system 1308, the computer program 1310, and the compiler 1312 are tangibly embodied in a non-transitory computer-readable medium, e.g., data storage device 1320, which could include one or more fixed or removable data storage devices, such as a zip drive, floppy disc drive 1324, hard drive, CD-ROM drive, tape drive, etc. Further, the operating system 1308 and the computer program 1310 are comprised of computer program 1310 instructions which, when accessed, read and executed by the computer 1302, cause the computer 1302 to perform the steps necessary to implement and/or use the present invention or to load the program of instructions into a memory 1306, thus creating a special purpose data structure causing the computer 1302 to operate as a specially programmed computer executing the method steps described herein.

Computer program 1310 and/or operating instructions may also be tangibly embodied in memory 1306 and/or data communications devices 1330, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1302. Alternatively computer can be part of a cloud or distributed system or server that is wirelessly connected or connected via a wired connection.

### References

The following reference is incorporated by reference herein.
[1] Meint Smit, Kevin Williams, Jos van der Tol; Past, present, and future of InP-based photonic integration. APL Photonics 1 May 2019; 4 (5); 050901. https:/doi.org/10.1063/1.5087862

### Conclusion

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What claimed is:

1. A transceiver chip, comprising:
an integrated circuit comprising:
an input for receiving coherent electromagnetic radiation outputted from a coherent source of electromagnetic radiation;
at least one aperture for at least one of transmission of transmitted electromagnetic radiation or reception of received electromagnetic radiation;
a wavefront processor comprising an array of nodes operable, in response to activation by a plurality of drivers and a plurality of control switches, for at least one of:
modulating the coherent electromagnetic radiation, when received from the coherent source, to form a waveform of the transmitted electromagnetic radiation transmitted by the aperture; or
determining a phase and an amplitude of a received waveform from received signals generated by the aperture in response to received electromagnetic radiation received on the aperture; or
configuring the aperture as at least one of a transmitter aperture for transmitting the transmitted electromagnetic radiation or a receiver aperture for receiving the electromagnetic radiation; and
wherein:
a sum of a number of drivers and a number of the switches is less than a number of the nodes, or
the switches 203 comprise control switches each controlling a splitter tree connected to a plurality of the nodes and a sum of the number of drivers and a number of the control switches is less than the number of the nodes.

2. The transceiver chip of claim 1, wherein:
the array of nodes are disposed in rows and columns;
the drivers, operable to set an operation state of a plurality of the nodes; are connected to a plurality of M common column driver lines or a plurality M of pairs of common column driver lines, wherein (for 1≤j≤M) the j^{th} one of the common column driver lines, or the j^{th} one of the pairs, couples the nodes in the j^{th} one of the columns to the j^{th} one of the drivers; and
each of the switches are connected to one or more of a plurality N of common row lines, wherein the i^{th} one of the common row lines (for 1≤i≤N) is coupled to the nodes in the i^{th} one of the rows.

3. The transceiver chip of claim 2, wherein P=M×N, where P is the number of the nodes.

4. The transceiver chip of claim 2, wherein the nodes each further comprise a diode isolating the nodes from one another so that current flows from the driver to the switch connected to the associated one of the nodes and not the other way around.

5. The transceiver chip of claim 2, further comprising a splitter tree comprising a splitter circuit connecting each of one or more of the switches, comprising control switches, to a subset of the common row lines, wherein the splitter tree comprises tree nodes comprising tree switches, each of the tree switches operable to switch a current from the each of the one or more control switches to one of the common row lines.

6. The device of claim 2, wherein:
each of the nodes comprises a charge storing device coupled to first diode in a forward bias configuration and a second diode in a reverse bias configuration, so that charge is applied to the charge storing device through the first diode and removed through the second diode;
each of the N common row lines comprise a reference or ground line;
the M pairs of common column lines each comprise a charge line and a clear line, wherein the charge line is connected to the first diode and the clear line is connected to the second diode;
to charge the charge storing devices at the i^{th} row and j^{th} column, the i^{th} one of the switches is closed while the remaining ones of the switches are open, and the one of the drivers of the j^{th} one of the pairs biases the first diode through the charge line while the remaining ones of the diodes are floating; and
to discharge the charge storing device at the i^{th} row and j^{th} column, the i^{th} one of switches is closed and the one of the drivers of the m^{th} pair biases the second diode through the clear line while the remaining ones of the diodes are floating.

7. The transceiver of claim 1, wherein the switches comprise transistors and/or optical switches, the nodes comprise modulators comprising phase shifters, the drivers comprise a digital-to-analog converters (DAC) with a voltage buffer applying a voltage or a current DAC applying a current, and the wavefront processor, the aperture, and the input from the coherent source are connected by optical waveguides.

8. The transceiver chip of claim 1, wherein the aperture comprises:
a photonic integrated circuit comprising an array of cells each comprising a polarization selective radiator component comprising an input from a transmitter waveguide and an output to a receiver waveguide, wherein the polarization selective radiator component accepts a first polarization of the coherent electromagnetic radiation from the transmitter waveguide and routes a second polarization of the received electromagnetic radiation, received on the polarization selective radiator, to the receiver waveguide.

9. The transceiver chip of claim 1; wherein:
the aperture comprises a photonic integrated circuit comprising an array of radiators each comprising an input/output interface to a waveguide;
the wavefront processor coupled to the waveguide is operable to configure the array as an optical phased array or a focal plane array.

10. The transceiver chip of claim 9, wherein:
the radiators comprise wavelength sensitive radiators,
the wavefront processor is operable to configure the array of radiators as an optical phased array controlling at least one of beam forming or beam steering of the transmitted electromagnetic radiation radiated from the radiators to form a plurality of resolvable spots in a far field, wherein a number of the resolvable spots is controlled by the wavefront processor controlling a wavelength and a direction of the transmitted electromagnetic radiation transmitted from one or more of the radiators.

11. The transceiver of claim 9, wherein:
the radiators comprise a wavelength sensitive radiator, and
the wavefront processor is operable to configure the array of radiators as a focal plane array controlling steering of the received electromagnetic radiation onto the radiators, so that a fill factor of the focal plane array can be increased by the wavefront processor changing a wavelength of the electromagnetic radiation transmitted from one or more of the radiators.

12. The transceiver chip of claim 9, wherein the radiator comprises a diffraction grating.

13. The transceiver chip of claim 9, wherein the wavelength sensitive radiator comprises a wavelength sensitive grating in combination with a lens, a wavelength insensitive grating in combination with a diffraction grating and a lens, or a wavelength insensitive radiator in combination with a meta-lens structure performing a function of a diffraction grating and a lens.

14. The transceiver chip of claim 1, wherein the coherent source is on the chip or off the chip.

15. The transceiver chip of claim 1, comprising a second array of nodes coupled:
to the coherent source for controlling the coherent electromagnetic radiation inputted to the input, wherein the coherent source further optionally comprises a plurality of sources emitting different wavelengths, or
to a plurality of the coherent sources emitting at different wavelengths operating in conjunction with a plurality of the chips.

16. The transceiver chip of claim 1, wherein the integrated circuit further comprises a calibration circuit coupled to the wavefront processor, the calibration circuit comprising a sample input for receiving a sample of the wavefront and an calibration output providing feedback to the wavefront processor in response to the sample, wherein the wavefront processor applies an adjustment to the wavefront in response to the feedback to at least partially cancel noise in the wavefront caused by at least one of manufacturing non-uniformities in the transceiver or an environment through which the transmitted electromagnetic radiation is transmitted.

17. The transceiver chip of claim 16, wherein the calibration circuit determines the adjustment from a comparison of a phase and amplitude of the waveform outputted to the aperture for transmission, with the phase and amplitude of the received waveform received on the aperture, at a plurality of different times for during a plurality of different time segments.

18. The transceiver chip of claim 16, wherein the calibration circuit estimates the adjustment by comparing a phase and amplitude of the waveform outputted to the aperture with for transmission, with the phase and amplitude of the received signals in real time as the received electromagnetic radiation is received on the aperture, and the adjustment is applied in an iterative manner so that the phase and amplitude of the received signal reaches certain acceptance criteria determined by the particular sensing application.

19. An integrated circuit comprising the transceiver of claim 16, wherein the wavefront processor sets an acquisition rate of the received signals commensurate with, or correlated, with the adjustment.

20. A system comprising the transceiver chip of claim 1, further comprising a control circuit coupled to at least one of the wavefront processor or the coherent source and operable to control the wavefront processor by routing control signals setting at least one of outputs from drivers, open or close state of the switches, wavelength of the coherent electromagnetic radiation outputted from the coherent source, or intensity of the coherent electromagnetic radiation outputted from the coherent source.

21. The device of claim 1, wherein the aperture comprises an array of radiators and comprises or is coupled to a tunable switch network transmitting the coherent electromagnetic radiation or waveform from the wavefront processor to the radiators, wherein the wavefront processor comprises the tunable switch network or is connected between the wavefront processor and the aperture.

22. . The device of claim 21, wherein the tunable switch network comprises an array of Mach Zehnder Interferometers (MZI).

23. The device of claim 21, wherein the tunable switch network can be configured for pass the coherent electromagnetic radiation going from broadband pass to narrowband pass, comprise a pass through for all wavelengths of the coherent electromagnetic radiation without posing as a bottleneck for wavelength steering of the electromagnetic radiation, or wherein the tunable switch network can be adjusted for narrowband operation for any particular wavelength of the coherent electromagnetic radiation.

24. A method of operating a transceiver, comprising:
controlling a plurality of nodes using a plurality of drivers and a plurality of control switches for at least one of:
controlling a waveform of electromagnetic radiation for at least one of beam forming or beam steering of transmitted electromagnetic radiation transmitted from the transceiver, or
determining a phase and an amplitude of a received waveform of received electromagnetic radiation received on the transceiver, or
configuring an aperture of the transceiver as at least one of a transmitter aperture for transmitting the transmitted electromagnetic radiation or a receiver aperture for receiving the received electromagnetic radiation; and wherein:
a sum of a number of drivers and a number of the switches is less than a number of the nodes, or
the switches comprise control switches each controlling a splitter tree connected to a plurality of the nodes, and a sum of the number of drivers and a number of the control switches is less than the number of the nodes.

25. The method of claim 24, wherein the nodes comprise modulators for modulating a phase and/or amplitude of the electromagnetic radiation.
